(19) United States
(12) Patent Application Publication
(10) Pub. No.: US 2010/0148515 A1
(43) Pub. Date: Jun. 17, 2010

(54) Direct Current Brushless Machine and Wind Turbine System

(76) Inventors: Mary Geddry, Coquille, OR (US); Gerald Sheble, Buffalo Grove, IL (US)

Correspondence Address: MICHAEL O. SCHEINBERG, P.O. BOX 164140, AUSTIN, TX, 78716-4140, US

(21) Appl. No.: 12/617,531

(22) Filed: Nov. 12, 2009

Related U.S. Application Data
(63) Continuation-in-part of application No. 12/472,114, filed on May 26, 2009, now abandoned.
Application No. 12/472,114 is a continuation of application No. 12/264,226, filed on Nov. 3, 2008, now abandoned.
(60) Provisional application No. 60/984,965, filed on Nov. 2, 2007.

(51) Int. Cl. F03D 9/00; H02K 21/12; F03D 1/04

(52) U.S. Cl. 290/55; 310/156.01; 415/220

(57) ABSTRACT

A direct current brushless electric machine is described that comprises a sequence of permanent magnets where the N and S magnetic poles being alternately arranged adjacent to each other, each exerting a magnetic field; phase coils are composed of a group of conductors, each conductor being laid essentially in parallel with each other, each coil being displaced by a full range of a single magnetic pole of the permanent magnet, such that each phase coil is alternately disposed adjacent to each other; and magnetic field or every other coil is in the same orientation to form an armature positioned opposite to the permanent magnet movable with respect to the armature with a predetermined amount of air gap provided between the phase coils and the permanent magnets. The electric machine operates as a generator when the power is flowing from a prime mover, such as the turbine blade extracting energy from the wind or water. The electric machine operates as a motor when the current is applied to the coils in a sequence to move the rotor when the turbine blades move the wind or water.

Also described is an aerodynamic system comprising inner and outer annulus disposed driving fans, with a pressure differential flow enhancing aerodynamic housing, able to concentrate and make laminar rough and turbulent intake air molecule flows, creating a smooth rotationally organized downstream vortex field, with maximum power extraction from building structure directed velocity flow enhancements.

The application is a continuation-in-part of U.S. patent application Ser. No. 12/472,114, filed May 26, 2009, which is a continuation of U.S. patent application Ser. No. 12/264,226, filed Nov. 13, 2008, which claims priority from U.S. Prov. Pat. App. No. 60/984,965, filed Nov. 2, 2007.

### FIELD OF THE INVENTION

The present invention is related to electric generators and motors, and in particular to a generator useful for generating electricity from the wind.

### BACKGROUND OF THE INVENTION

Wind is presently the fastest growing renewable energy source, averaging annual growth rates of 29% worldwide for the last decade. Most money and public interest invested in wind turbine projects generally has been invested in large wind farms with multi megawatt generating capability, even though such installations normally occur in remote locations far from the electric power consuming market. These remote power installations are initially very capital intensive: utility substation systems and long range transmission lines must be added to the installations delivering electrical power to the end consumer. As the percentage of power produced by big wind turbines becomes a larger percentage of total produced electrical power, the reliability and intermittent generating nature of wind power becomes a serious problem.

In Scandinavia, Europe, Texas, and elsewhere, the intermittent nature of wind power requires the concurrent construction of backup conventional power generating capacity, which is operated at an inefficient idling rate, until required when the wind turbine electrical output reduces from diminished available wind.

Grid reliability questions, the high costs of power transmission and even national security provide reasons for moving away from centralized power production and toward wide scale distributed power generation. While distributed energy will contribute 11% to the US expected increase of 450,00 MW by 2025, only 3% is from renewable sources because of issues surrounding safe wind power generation in congested urban locations. Distributed wind generation is held back by a lack of efficient, reasonably priced technology.

### SUMMARY OF THE INVENTION

It is an object of this invention to provide an improved brushless direct current machine for multiple applications and to provide an improved wind generator that can, in some embodiments, use the DC machine as generator.

A DC machine, that is, a machine that can be used as a direct current motor or a direct current generator, has two housing shells assembled together forming a housing accommodating a stator annulus, stator coils, rotor annulus, rotor magnet, and necessary electronic circuit elements. In many embodiments, the rotor and stator diameters are large compared to the prior art, and the large diameter machines provide room sufficient for all necessary parts, with the stator in fixed position operating correctly, with no necessary trade off between rotor size and mass. Traditional rotors are miniaturizations of the cylinders (i.e., the rotor diameter) for high efficiency and must operate at high speeds to introduce high relative moving magnet, stationary induction coil velocities.

In one embodiment, the rotor is enlarged as part of the wind annulus and has a naturally high velocity because of its large circumference. Intrinsic high velocity and increasing inertia for smooth operation produce nearly a sinusoid voltage before or after rectification.

### BRIEF DESCRIPTION OF THE DRAWINGS

FIG. 1 is an oblique front view of a fully integrated ducted fan integrated brushless generator, turbine housing and rotating base.

FIG. 2 is an oblique rear view of a rotor and stator assembly, as included in the generator of FIG. 1, and also showing the wake expansion downstream cylinder.

FIG. 3 is a cutaway plan detail view of a typical rotor/stator section assembly showing the spatial relationship between the moving rotor magnets, stationary inductive core, and coil targets, with the bridge rectifiers and one of two output busses shown.

FIG. 4 is a plane line view of rotor and stator elements shown in circular fashion illustrating further spatial relationships between magnet rotor elements, and the stator coil and core flux target elements.

FIG. 5 is a planar side view of rotor and stator elements shown in circular fashion, adding magnetic field flux lines showing the closed flux magnetic field line relationships between moving rotor magnets, and fixed stator elements.

FIG. 6 is a plane side view showing one stamped thin metal segment of the multi-laminated stator structure many laminations into the page thick, showing a representative coil as wound over the stacked stator elements.

FIG. 7 is a top down plan view of the electrical interconnections on the stator: inductive flux target core/coil output wires drive bridge rectifiers which in turn drive output busses lower buss is shown.

FIG. 8 is a side view of the rotor, stator, and axle assembly, showing the wake stream flow augmentation control cylinder fully open behind the fan structures.

FIG. 9 is a side view of the rotor, stator, and axle assembly, showing the wake stream augmentation control cylinder fully closed behind the fan structure.

FIG. 10 is a side view of the rotor, stator, and the axle assembly showing the addition of an outer annulus fan blade system as disposed on the outer perimeter of the rotor. This page also shows a typical outer blade detached from the rotor perimeter, for relative size and shape determination of the blade.

FIG. 11 is again a plan side view of the rotor, stator and axle assembly showing the addition of index (i.e., turning the turbine into the wind) and directionality controlling power flap elements disposed as co-planar extensions of the basic annular rotor shape and slope. These power flaps and accompanying air stream flow slots enhance both instant indexing for the ducted fan wind system, and stream flow control.

FIG. 12 is a top down plan view showing total vortex field generalized plane air molecule stream flow lines for the entire active ducted fan wind system, with the back of center fan disposed flow controlling cylinder in the open position.

FIG. 13 is again a top down plan view showing total vortex field generalized air molecule stream flow lines for the entire active ducted fan wind system, with the back of center fan disposed flow controlling cylinder in the closed position.

### DESCRIPTION OF THE PREFERRED EMBODIMENT

A preferred embodiment of a wind turbine in accordance with the present invention comprises a ducted wind turbine having the rotor and stator positioned near at end of the fan blades away from the axis of rotation.

Ducted wind turbines include a structure near the turbine that affects the wind flow through the turbine blades. Wind turbines of all sizes have long been built with associated structures and housings that provide aerodynamic features which affect the air flow through the turbine. The Persians, several thousand years ago, at the time of the attempted Greek conquests, were building various cooling towers, and small open fan type turbines, which were placed within sided structures, open in the direction of incoming and exiting wind flow. Some early 20th Century machines also featured housings and blade tip confinement schemes for legitimate reduction of power limiting blade tip vortices generated at radial right angles to the axial air flow.

A study funded by the Carbon Trust in the UK noted the untapped potential of roof mounted wind turbines. The study revealed a 180% velocity gain associated with wind tumbling over rooftops. Most importantly, since the power of the wind is proportional to the cube of the wind velocity, volume flow gain offers large significant benefits in power production. Although many noted wind turbine designers, such as Hugh Piggott in Europe, agree that properly conceived ducts can increase power production compared to open fan turbines, many designers also believe that the added complexity and cost of the duct structure limits the practical application of building related small scale wind turbine designs.

Applicants have found that wind power can be efficiently produced right at the point of power consumption, especially by smaller ducted fan wind turbines operated that take advantage of the wind flow around commercial and residential structures, where wind stream flow is naturally turbulent and requires efficient aerodynamic features.

In accordance with one aspect of some embodiments of the invention, a brushless DC generator is provided that is free of the conventional machine drawbacks described above and integrated mechanically into the structure of the wind turbine.

In accordance with another aspect of some embodiments of the invention, a brushless DC machine is provided that is relatively flat within the wind annulus, is compact, has high yet constant torque, and is easily and inexpensively manufactured.

In accordance with another aspect of some embodiments of this invention, a brushless DC machine is provided in which the rotor shaft need not be connected to the stationary parts of the machine by a traditional yoke design.

A DC machine is described having two housing shells assembled together forming a housing accommodating a stator annulus, stator coils, rotor annulus, rotor magnet, and necessary electronic circuit elements. Large diameter machines, that is, machines having a rotor diameter of greater than one foot and more preferably greater than two feet, and most preferably greater than three feet or four feet, have sufficient room for all necessary parts, with no necessary trade off between rotor size and mass.

Traditional rotors minimize the rotor diameter to improve efficiency and must operate at high speeds to introduce high relative velocities between the moving magnets and the stationary induction coils. Embodiments of the invention use a rotor that is enlarged to be part of the wind annulus, and provides a naturally high relative velocity from a large circumference. That is, whereas in traditional wind turbines, rotor magnets are mounted near the axis of the turbine, in a preferred embodiment of the invention, the rotor magnets are mounted near the outer diameter of the turbine, away from the central axis. Intrinsic high velocity and increasing inertia for smooth operation produce nearly a sinusoid voltage before or after rectification. Such advantages are difficult to achieve at the small rotor diameters of the prior art. Further, prior art DC machines require thrust pads or an annulus made of a specific, relatively expensive alloy. Providing an electrical connection grounding the rotor shaft in such machines is difficult. Such grounding is simplified embodiments of the invention.

Prior art wind generators operated only within a limited range of wind speeds, because too great a wind speed would generate excessive current that would overheat the coils and too low a wind speed failed to provide sufficient torque to start the blades moving, without assistance. Embodiments of the invention can provide a much wider wind speed bandwidth than traditional generator designs. The ducted fan wind turbine into which embodiments of the generator are fully integrated need never be aerodynamically or electrically shut down in very high wind speeds because heat generated by the generated current is spread over a large area and because the current carrying components are cooled by the high speed air flow. Some embodiments of the invention can generate electricity at winds speeds from as low as 2 mph to 100 mph or even higher.

Embodiments of the invention typically include a brushless DC machine comprising a rotor upon which are mounted a set of magnets; a stator including multiple inductive coils wound around magnetic cores and facing the rotor magnets in an overlapping predetermined angular relation to each other about the axis of the rotor shaft; wiring to connect the stator coils disposed on the stator assembly in non-overlapping relation to the stator coils.

Detecting elements, known as field sensors, can be mounted on the stator assembly, sensing the rotational position of the rotor magnet and providing a correspondingly modified current, fed to the stator coils exerting such control in accordance with the electrical angle of the rotor magnet when operated as a motor. Such sensors are less useful when the machine is operated as a generator. Also, in some embodiment when the system is used as a motor, the angular position of the rotor can be determined from the current in the various stator coils. The determination of the angular position from the current in the stator coils is known in the art.

From an aerodynamic performance point of view, embodiments of the invention can provide an extremely compact, efficient, concentric double turbine fan system, automatically self-steering directly into the wind almost instantaneously, therefore safely producing maximum power from velocity increased turbulent wind flow streams. Adjacent buildings and structures deflect and reflect stream flows, increasing intake air mass volume velocity.

Duct structures of the present invention are desirable, not only for the aerodynamic affects, but also for blade tip safety control and to prevent destructive ingestion of birds and butterflies into the fan system, common in urban residential or business environments, duct structures form a necessary complement to the bladed fan.

Embodiments of the present invention eliminate redundant aerodynamic structures, seeking the minimum required physical architectural fan housing. Depending on the application, embodiments of the invention are guided by the design principals of absolutely safe, quiet aerodynamic operation in close proximity to commercial and residential airflow augmenting structures. Many of the prior art systems feature quite complex physical and mechanical associated structures of dubious merit.

Embodiment of the present invention incorporates the generator itself within the literal physical architecture of the wind turbine, so that the total system is not in any way output power limited by the generator, an important consideration where building directed air flow velocities, and consequent power production can be extremely high. As described above, the electrical current limitations of past generators required the system be shut down at high wind speeds, which is when the system could be delivering maximum power, because the generator was unable to handle the power.

Embodiments of the present invention describe a brushless DC generator/motor for efficient use as an integrated ducted fan wind generator, as a thrust motor for marine maneuvers, and for other round generator/motor device purposes. This application specifically describes a brushless DC generator fully integrated into a highly efficient ducted fan wind turbine, or WT, producing a very large yet constant torque at different speeds, made as part of the WT aerodynamic moving surface, cylindrically flat and compact, and capable of being easily and inexpensively manufactured.

The turbine in a preferred embodiment further combines the rooftop flow gain effect with an additional 20% air mass velocity gain by inducing a pressure drop or Bernoulli Effect behind the fan. Properly situated on a rooftop or steep hillside, the turbine can extract more power per swept surface area than any equivalent size open bladed turbine.

The turbine in a preferred embodiment is self-indexing, silent, and vibration free, operating comfortably in high winds and easily managing gusting, turbulent airflow, making it suitable for rooftop mounting and extensive use in urban settings. The fan tips are terminated by an outer ring or annulus and can be screened to protect birds.

The turbine in a preferred embodiment implements aerodynamic features with a high-bandwidth direct drive DC generator designed to operate at variable wind speeds. The generator is built into the outer annulus making the turbine a self-contained, unitized generator.

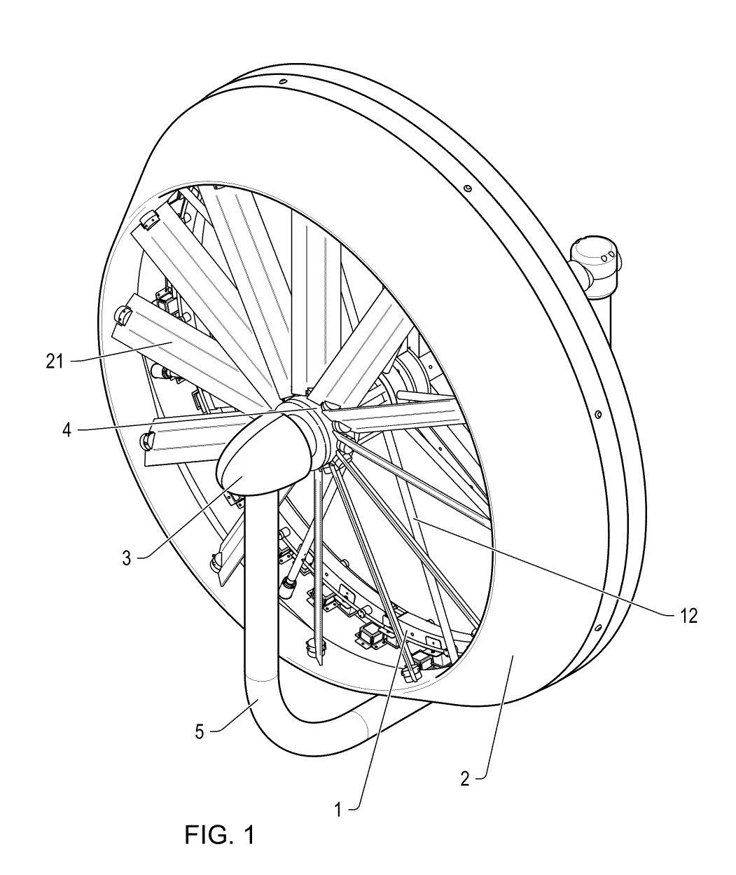

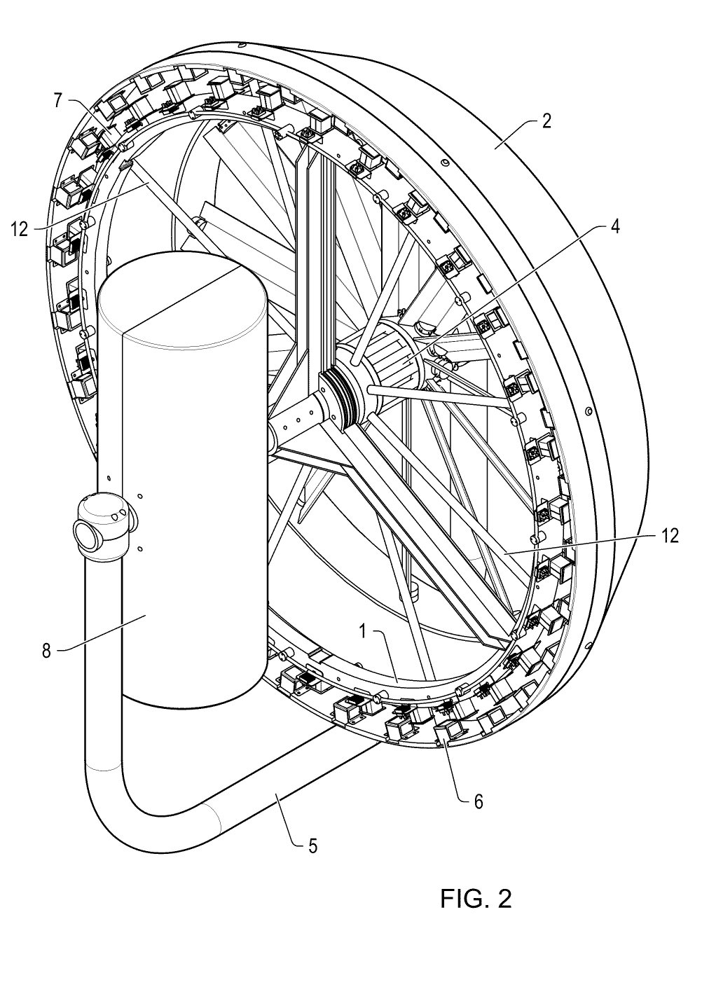

Referring initially to FIGS. 1 and 2, embodiments of the DC generator of this present invention generally comprise a rotor/stator assembly. The rotor assembly 2 is integral with the moving cowl of the blade assembly 21, FIG. 1. A center portion of the rotor assembly 2 is adjacent to the stator assembly 1 using a set of bearings maintaining a minimum air gap between the rotor/stator assembly at the circumference, consisting of an inner sleeve, preferably of brass, and an outer housing, preferably of a plastic synthetic resin, and having a flange for attachment to the stator assembly prohibiting the flow of objects into the air gap. Stator assembly 1 is fixed to a support base 5. The support base 5 includes two vertical portions that support a horizontal axle 4 running between them. The support base 5 rotates about a vertical axis 4, allowing it to automatically face into the wind. Rotor assembly 2 rotates about the horizontal axle 4 as wind induces rotation of the blades 21. Stator assembly 1 is supported by spokes 12 that attach to a hub on horizontal axle 4 portion of the support base 5. A spinner 3 is attached to the forward end of the axle 4 and improves the aerodynamic profile of the center portion of the turbine assembly. A wake stream flow augmentation control cylinder 8, most notably shown in FIG. 2, resides behind the rotor shroud, that is, from the direction of incoming winds, and can be induced to change conformation such that it can increase or decrease the amount of wind wake flow that is permitted to pass through the shroud, thus affecting efficiency and energy generation.

The rotor 2 preferably includes an outer ring connected to the blades 21. The ring may be in a conical shape on its exterior surface (furthest portion from the rotor shaft axis of rotation, or horizontal axis 4) and may have an inner surface (closer to the horizontal axis of rotation) that is generally planar to the axis of rotation. The rotor assembly 2 and is rotationally attached to the horizontal axle 4 through the blade assemblies 21 which terminate at a rotatable hub around the axle 4. The rotor magnets 6 are suitably secured on the rotor 2 at the side the stator assembly 1.

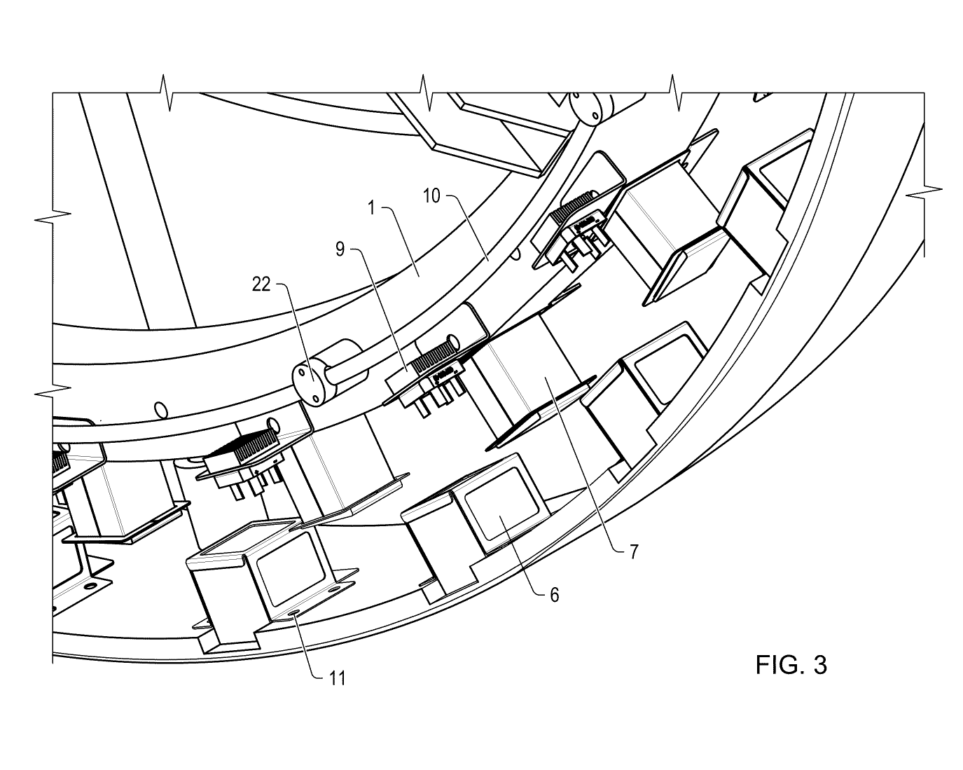

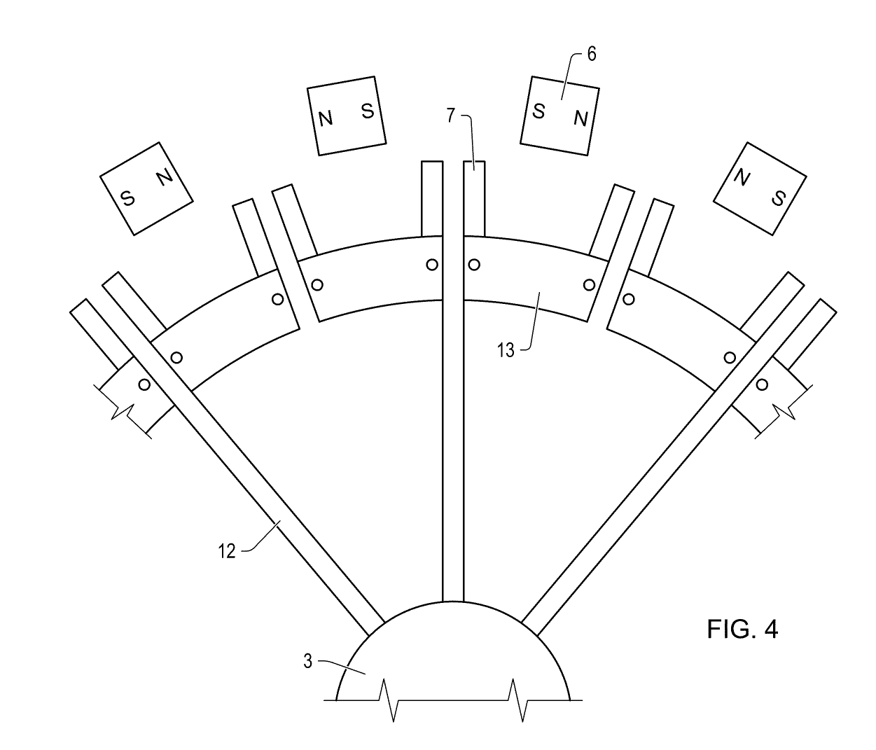

Stator assembly 1 (FIGS. 2 and 3) is shown including an annular assembly with stator coils 7 mounted. In a preferred embodiment, as shown on FIG. 2, there are preferably sixty stator coils 7. As shown in more detail in the enlarged view of FIG. 3, each coil 7 includes an inductor, in non-overlapping relation to each other. Further, the stator coils/inductor core targets 7 are disposed on the stator 1 with predetermined equal angles between the pair of stator coils and the pair of magnets 6 respectively. The stator coils 7 are wound on respective winding blocks of equal shape and axial depth occupying equal angles about the axis of the rotor shaft 4. The stamped steel winding blocks (reference numeral 13 of FIG. 4) are laminated steel, saturable reactor, inductive targets, and may be secured to the circular base plate or wall of stator assembly by non-inductive adhesives.

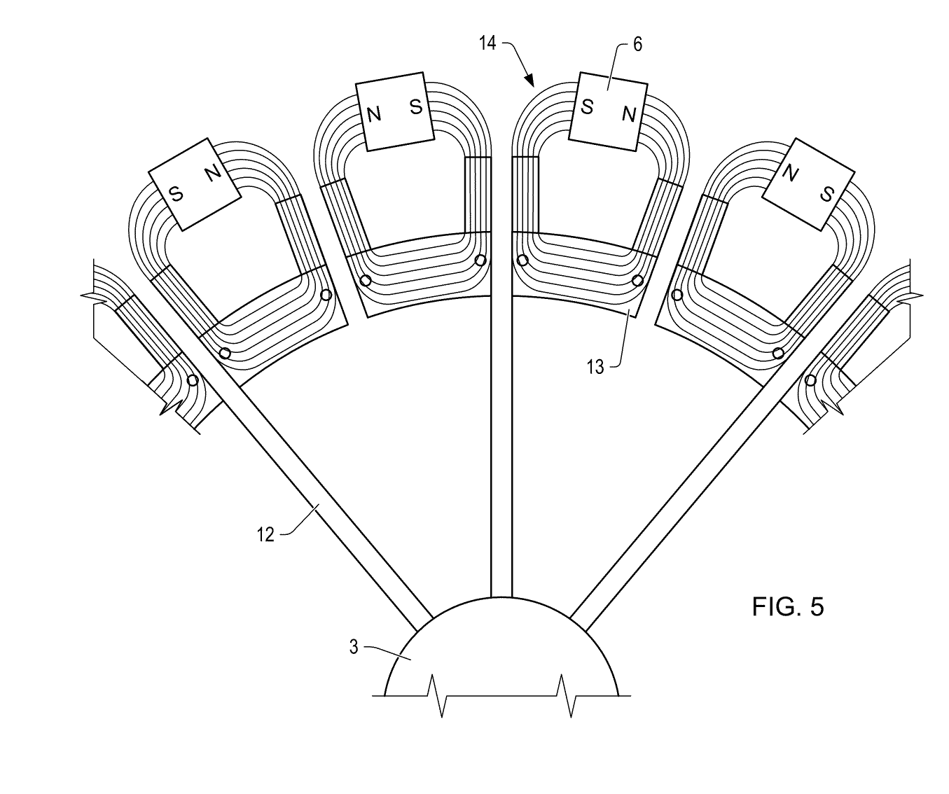

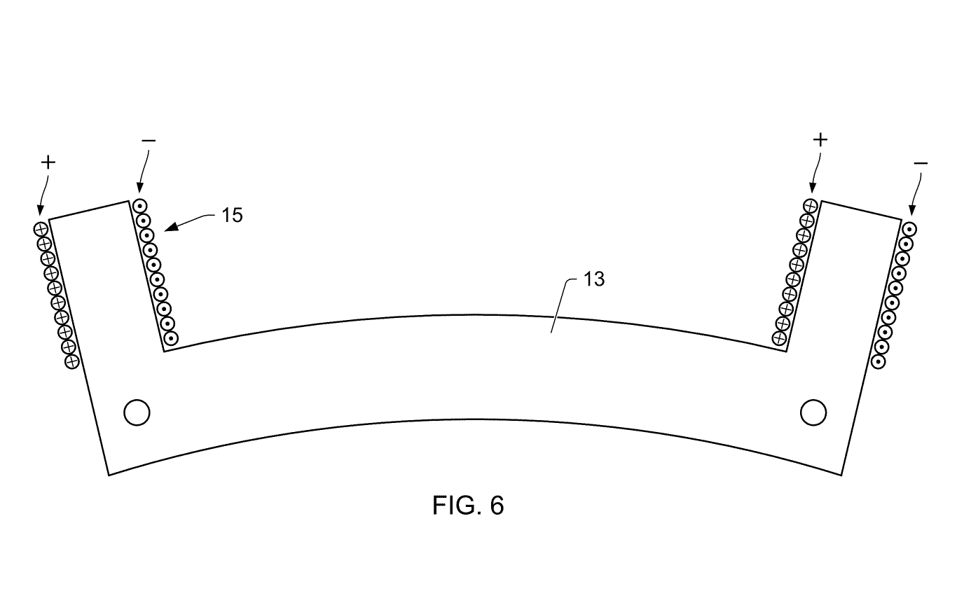

FIG. 3 shows further shows, in an enlarged view of a portion of the rotor and stator assemblies, the rotor magnet 6 having a cubic shape. FIG. 4 shows the magnets as having an even number of magnetic poles; North poles alternating with South poles. The rotor magnet poles are preferably circumferentially spaced at equal angular distance, so that the rotor magnet moving magnetic flux density is a sine wave with the rotational angle of the rotor assembly. Flux 14 (FIG. 5) from the rotor magnets passes through the inductor inside the stator coils, through stamped thin steel sheets 13 make up the stator torus and back through the other inductor and stator coil of the pair. On a leg of the stamped thin steel sheets 13 are wound multi-layer coils 15 on the torus stator leg element. FIG. 6 shows one stamped thin metal segment 13 of the multi-laminated stator structure. The stator portion includes many laminations of metal segments 13, with the stator coil 7 wrapped over the stacked stator elements 15.

Each of the stator coils is arranged having generally rounded edges, respectively in a squared leading and trailing relation to rotor assembly direction. Each of the stator coils is dimensioned with angular distance between leading and trailing edges as equally spaced with regard to n (in which n is the number of poles of the rotor magnet). In the illustrated example, the rotor magnet has thirty pole pairs. The angular distance between the leading and trailing edges of each stator coil is between consecutive poles of the rotor magnets.

Stator coils 7 are further arranged on stator assemblies with the trailing edges of the stator coils spaced from the leading edges of stator coils, respectively, by electrical angles of 90 degrees. All stator coils are connected in parallel respectively, and leads extend from each coil to bridge rectifiers 9. These rectifiers are connected to copper annular busses 10 (only one of two shown in FIG. 3) which are electrically isolated from the stator by buss standoffs 22. Busses 10 then drive loading elements matching an inverter, and following utility hookup (not shown). As also shown in FIG. 3, the magnets 6 are retained on the rotor using magnet retainers 11, which comprise a non-magnetic material that will not distort magnetic flux lines (shown as reference numeral 14 in FIG. 5).

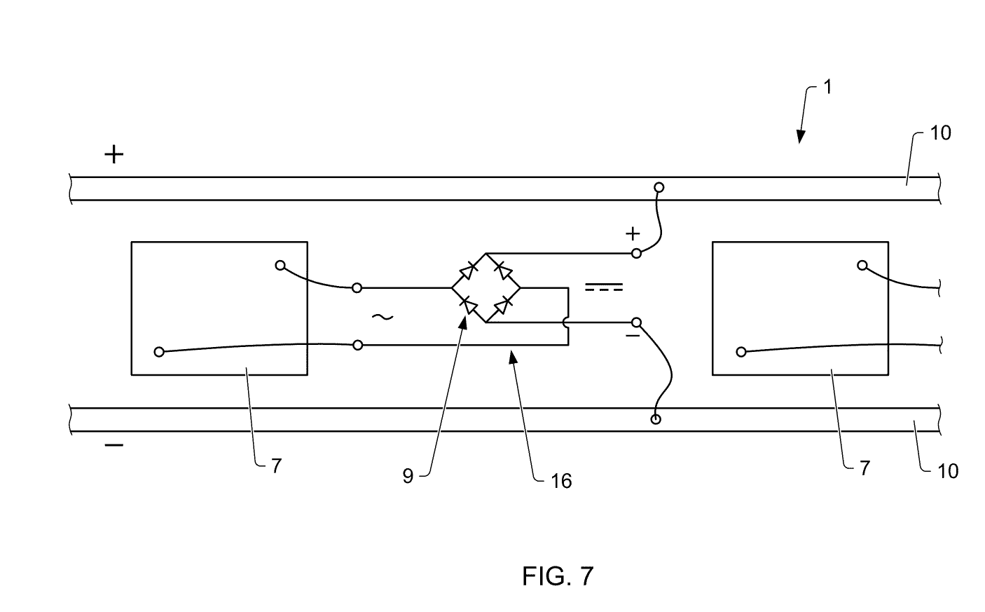

FIG. 7 shows the electrical interconnections on the stator 1. Inductive flux target core/coil output wires 16 from the stator coils 7 connect to the rectifier bridge 9, and then to either the positive or negative buss 10. Each stator coil includes a rectifier.

An alternative AC embodiment, not shown, polarity inverts every other coil pair, thus producing sinusoidal AC without any on board rectifier connections, into a purpose built novel AC inverter, with integrated rectification.

Sensors or elements, not shown, can be mounted on the stator, sensing the rotational position of the rotor magnets, angularly spaced from each other about the axis of the rotor shaft by an electrical angle of 90 when the machine is operated as a motor. Sensor elements can be further arranged so that each sensor element is separated from the adjacent or trailing edge of stator coil by an electrical angle of 90°, and further so that the sensor element is separated from the leading edge of stator coil by an electrical angle of 90°. Sensor elements can be shown schematically to operate as detectors, responding to the rotational position of the rotor magnets, providing corresponding control voltages to suitable control circuits, by which currents supplied from circuits to the series connected stator coils and are regulated or controlled.

Alternatively, also not shown, the induced inductive peaks of the saturable reactor target coils can be easily sensed, and modified, as an integrated, motor controller without the addition of any ancillary sensing equipment.

An optional wiring board, not shown, may be made of a rugged non-conducting material, such as paper impregnated with epoxy resin, formed in rectangular configuration, facilitating the close nesting of stator coils and wiring board on the plane wall surface of the stator assembly, avoiding overlapping of the wiring board and of the stator coils. The wiring board can be parallel to the axis of the rotor shaft and the center can extend adjacent the end of the rotor shaft provided with a ball bearing. Thus, the axial engagement of the bearing against the center of the wiring board provides a thrust bearing for the axial load on the shaft.

A convenient ground for the shaft can be provided by a layer or pad of copper foil or other conductive material and be applied to the edge of the rotor assembly then engaged by the ball bearing of the shaft. The printed circuit on the wiring board for connections to the stator coils are preferably arranged with connections are all made at one end of the wiring board by lead wires (not shown) extending through an aperture in the stator assembly. Either a wiring board or a symmetrical buss system can perform the obvious function of providing the necessary connections to the stator coils and the sensor elements, and also the functions of providing an axial bearing for rotor shaft and connecting the latter to ground by way of a printed circuit.

The machine generator provides a constant torque independent of the rotary position of the rotor magnets. The rotor magnet is oriented providing a magnetic flux density varying as a sine wave with the rotating angle of the rotor. When the stator coils and sensor elements or detectors are arranged as described above, the currents applied to the stator coils cause the magnetic field of the stator assembly to interact with the magnetic field of the rotor assembly exerting a constant rotational force on the rotor magnet.

The force due to a magnetic field acting on a current-carrying wire is proportional to the product of the magnetic flux density B and the current i in the wire. Since the rotor magnet provides a magnetic flux density varying as a sine wave with the rotational position of the rotor magnet, and since coils are respectively spaced from each other by half the angular distance between consecutive magnetic poles of the rotor magnet, that is, by an electrical angle of 90 degrees, the magnetic flux density B, acting upon each of coils and the magnetic flux density B2 acting on each of coils can be defined as follows:

B₁=B_{M} sin(θ) Equation 1

B₂=B_{M} cos(θ) Equation 2

θ is the electrical angle of rotor and BM is the maximum value of magnetic flux density from any of the poles of rotor magnet. Because sensor elements are separated from each other by an electrical angle of 90•, the voltages e1 and e2 obtained from sensor elements, respectively, vary with the rotational position of rotor assembly as follows:

e₁=K₁ sin(θ) Equation 3

e₂=K₁ cos(θ) Equation 4

K1 is a constant. If currents proportional to the voltages obtained from sensor elements are provided to coils and to coils from current control circuits, respectively, a current i₁ flowing through coils, and a current i₂ flowing through coils may be derived from equations (3) and (4) as follows:

i₁=K₂ sin(θ) Equation 5

i₂=K₂ cos(θ) Equation 6

With K2 is a constant. Assuming that the force acting on coils is F1, and that the force acting on coils is F2; and since the force acting on each stator coil is proportional to the product of the magnetic flux density applied to the respective coil and the current flowing there through, the forces F1 and F2 can be expressed as follows:

F₁=i₁B₁=K₂B_{M} sin²(θ) Equation 7

F₂=i₂B₂=K₂B_{M} cos²(θ) Equation 8

Accordingly, the total force applied to the rotor assembly is the sum of the force from each coil:

$$\begin{matrix}{F}_{T} = {F}_{1} + {F}_{2} \\ = {K}_{2} {B}_{M} {sin}^{2} ( θ ) + {K}_{2} {B}_{M} {cos}^{2} ( θ ) \\ = {K}_{2} {B}_{M} ( {sin}^{2} ( θ ) + {cos}^{2} ( θ ) ) \\ = {K}_{2} {B}_{M}\end{matrix} \qquad Equation 9$$

Thus, equation (9) reveals that the rotational force F applied to rotor assembly 11 is a constant independent of the electrical angle θ and hence independent of the rotary angle, of rotor assembly. Therefore, the DC machine according to this invention provides a smooth rotation, free from the fluctuations in torque. Further, in the described DC machine, the current flowing through each stator coil is not switched, as in the prior art, but is modified continuously, so that there is no noise or mechanical sound associated with the supplying of current to stator coils.

Since the number of stator coils may be small as compared with the number of magnetic poles on rotor magnet, it is possible to arrange the stator coils in non-overlapping relation to each other. Also, the stack of windings for each stator coil can be made in a single stage. Therefore, the axial distance between rotor magnet and stator assembly, and hence the thickness of the machine, can be reduced. This reduction in dimension results in an increased density of magnetic flux, therefore, this generator invention provides a torque equivalent to, or higher than a generator having a relatively larger number of stator coils arranged in overlapping relation to each other, formed in winding stacks of several stages. The preferred number of coil/inductor structures is equal to the number of magnetic poles.

Because the stator winding blocks are arranged on stator assembly in non-overlapping relation to each other and to the wiring board, the axial distance between rotor magnet and stator assemblies is not related to the thickness of wiring board. Thus, this invention provides a machine relatively flatter than prior art machines in which winding blocks for stator coils are disposed on a wiring board. The density of the magnetic flux, and hence the torque, are further increased by this reduction in axial distance between rotor magnet and stator assembly. Further, since each stator coil consists of winding stacks in one stage, and the axial dimensions for the four stator winding blocks are equal, the gap between rotor magnet and the winding blocks can be easily and precisely determined, thereby simplifying assembly.

In the illustrated embodiment, the winding of stator coils on winding blocks can be contrasted with a typical prior art brushless DC machine, in which the coils are wound directly on the stator assembly and/or other fixed members. By winding the stator coils on individual winding blocks simply attached to stator assembly, the precise positioning of the stator coils can be achieved economically and without difficulty.

The invention is not limited to the embodiment shown in the drawings. For instance, magnets may be placed on either side of the coils or magnets may be placed on both sides of the coils. Further a generator can be built having a two-pole rotor magnet, and a stator having two stator coils separated from each other by an electrical angle of 90° with the stator coils being in non-overlapping relation to each other. Even when the rotor magnet has a greater number of poles, for example, more than eight, the number of stator coils can be selected so that the stator coils do not overlap each other, and such coils arranged so that those not connected in series with each other are separated from each other by an odd multiple of an electrical angle of 90°.

It is also possible in connecting rotor shaft to ground, to electrically connect the stator assembly so that the stator assembly is also grounded.

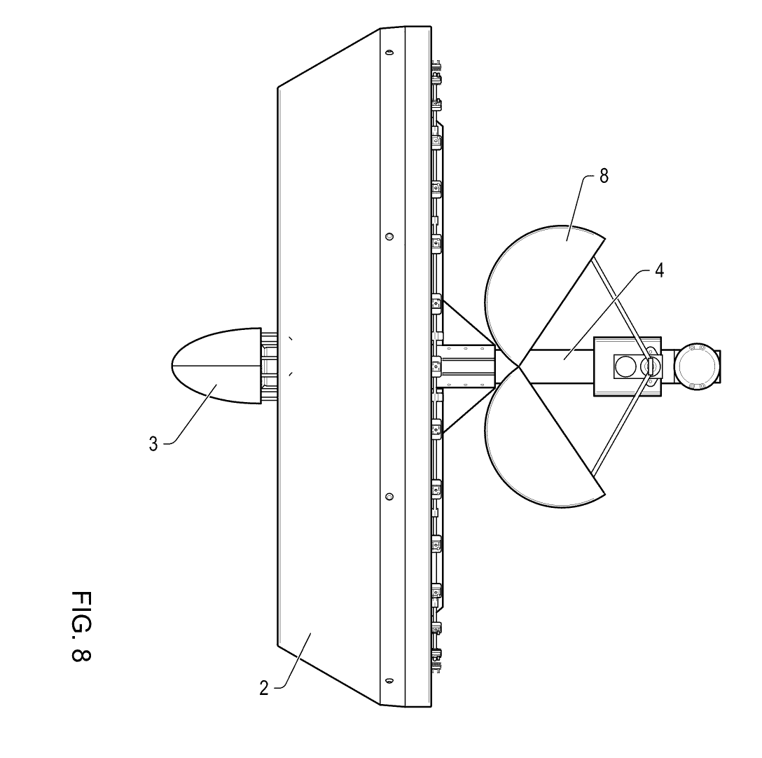

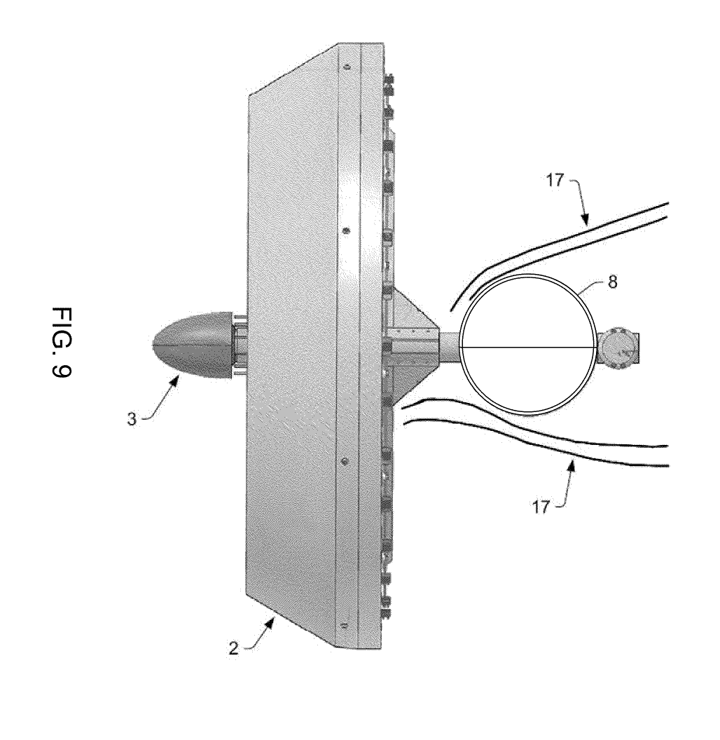

FIG. 8 shows a side view of the rotor, stator, and axle assembly, showing the wake stream flow augmentation control cylinder 8, fully open behind the fan structures. Wake stream flow augmentation control cylinder 8 can be a Von Kármán vortex street generator. The opening of the vortex generator is opened or closed by an actuator mechanism, such as worm screw turned by an electric motor. At low wind speeds, the control cylinder 8 is operated in the half opened position to form a low-pressure region behind the fan, increasing the air flow through the fan. FIG. 9 shows the same elements as FIG. 8, but with the control cylinder closed for use at higher wind velocities, indicated by wake stream flow lines 17.

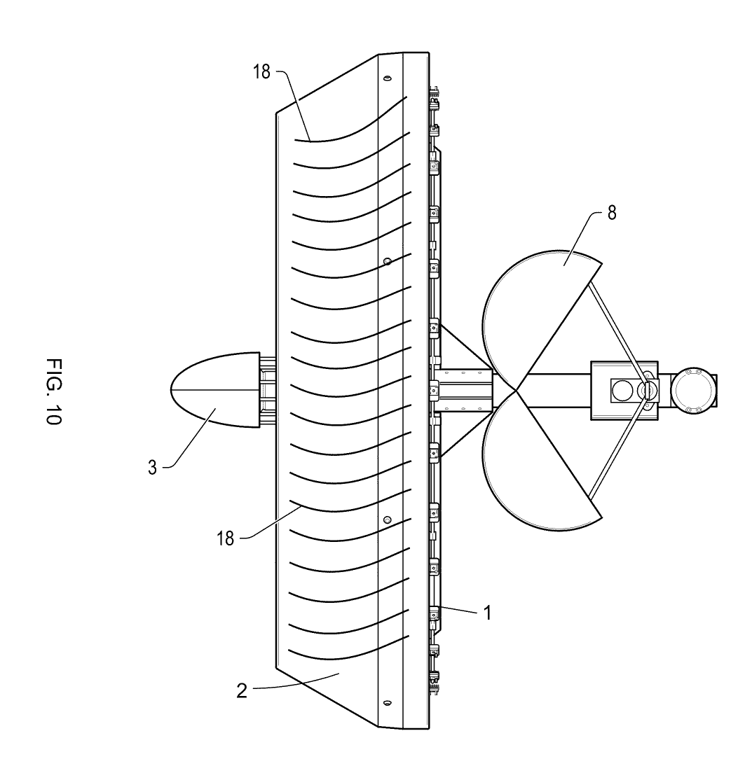

FIG. 10 shows a side view of the rotor 2, stator 1, and the axle assembly showing the addition of an outer annulus fan blade system 18 disposed on the outer perimeter of the rotor 2. The outer blades 18 reduce frictional drag on the rotor by creating vortices as turbine spins. If the outer blades are sufficiently high, they also provide additional surface area to pick up wind, like additional fan blades. Short blades, for example about one inch high, would reduce drag but not provide much additional torque. Longer blades, such as a foot high, would also provide additional torque.

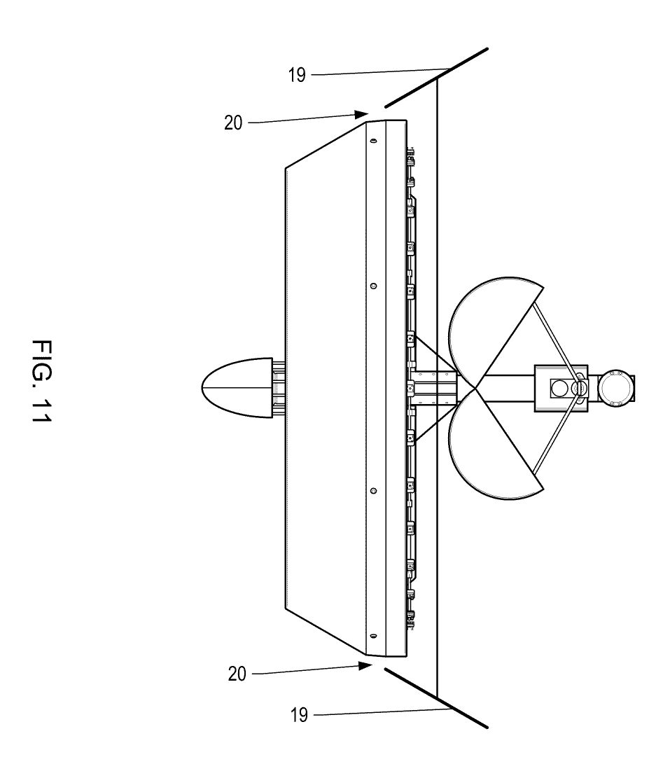

FIG. 11 shows angled steering and power output augmentation flaps 19. The aerodynamic principles in use here are as follows:

The flaps represented are co-planar extensions of the rotor angle shape. As such, by deflecting a volume of air outward, each flap 19 in turn exerts a rotational torque through the rigid linking arms inward. For example, if the upper flap at the top of the drawing were angled outward at a steeper deflectional angle, the entire wind turbine system would rotate clockwise. The value of the system from a precise steering/indexing point of view is that it is balanced and differential, exerting a tremendous amplified torque on the center mount.

The COANDA aperture 20 causes the streamflow after the angled rotor shape to track and conform to the inside of the power flap, thus using both the inside and the outside of the power flaps to control both steering or “automatic indexing”, while holding the wake open, maintaining the virtual pressure difference between inner and outer wake flows aft of the fan. The flaps induce a virtual wall behind the fan forcing the air to try and equalize the pressure by flowing only through the fan.

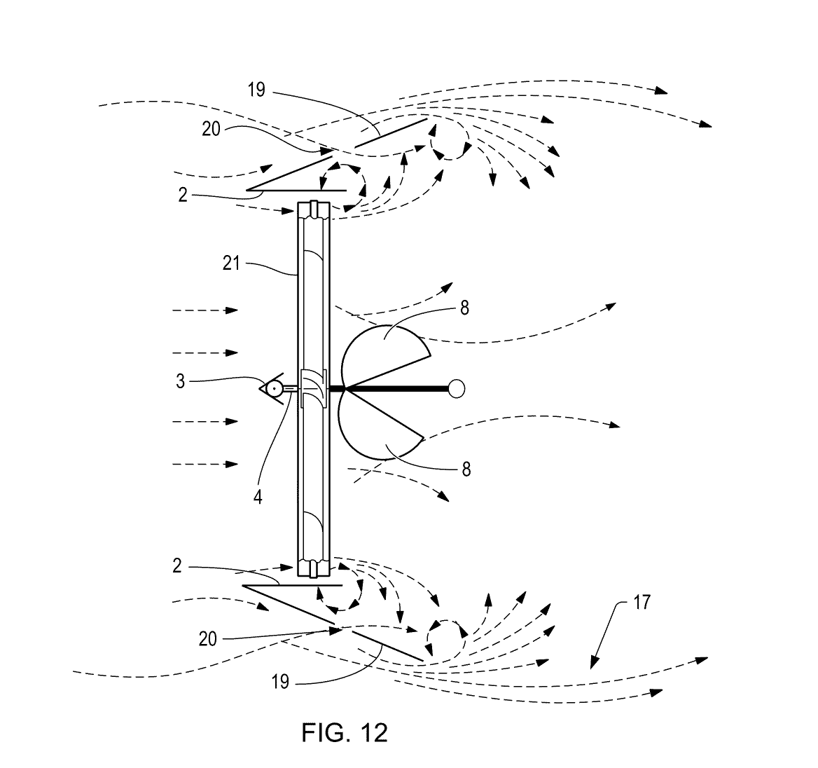

FIG. 12 shows the total vortex field generalized plane air molecule stream flow lines 17 for the entire active ducted fan wind system, with the back of center fan disposed flow controlling cylinder in the open position.

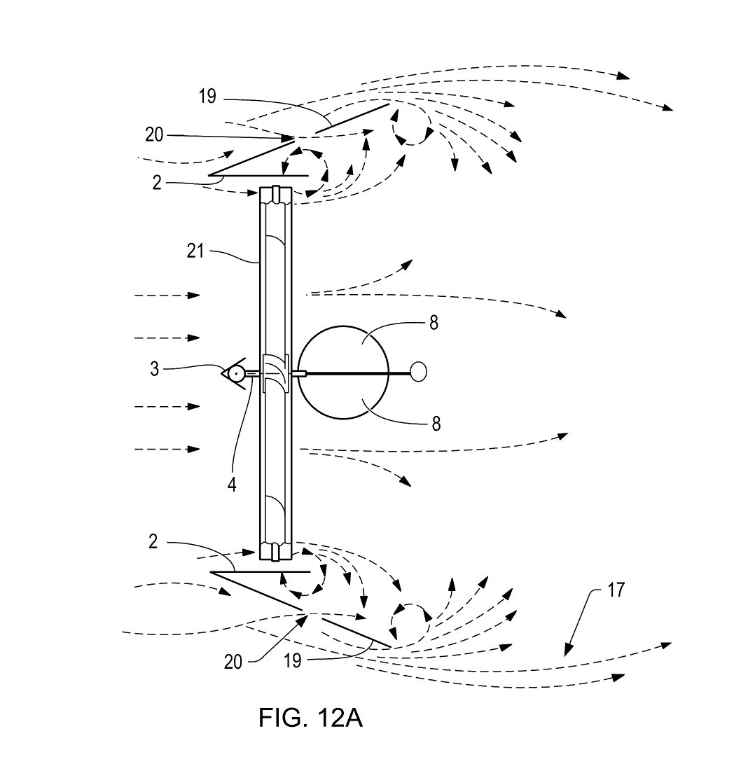

FIG. 13 is again a top down plan view showing total vortex field generalized air molecule stream flow lines 17 for the entire active ducted fan wind system, with the back of center fan disposed flow controlling cylinder in the closed position.

Embodiments of the present invention may contrast the single vertical stabilizer as often used in wind turbines with the balanced differential design. In such a system having a traditional vertical stabilizer, the extended flat plane of the stabilizer divides the stream flow. If the stream flow is unequal, then the pressure on either side of the stabilizer is unequal, thus turning the attached fan into the direction of low pressure.

In the embodiment as shown in FIG. 11, the long lever arms of the angled complementary flaps 19 multiply the indexing torque of the double steering flaps, which have potentially double the surface area of a conventional vertical stabilizer. Very rapid automatic, self steering, accurate indexing is very desirable in the turbulent high velocity intake stream flow associated with turbine operation in conjunction with building and structure shapes.

The relationship is a Newtonian Third Law relationship: the more outwardly angled flap exerts a greater force in deflecting more air at a sharper angle. In turn the deflected air exerts a force on the more outwardly extended flap, trying to normalize or make the pressure equal. This force is applied the center bearing as a rotational torque in a clockwise direction. The deflection force can also be stated in constructive drag terms.

Another aspect of preferred embodiments of the invention which differs from other ducted fan wind turbines is that such embodiments of the present invention fully integrate steering functions with wake expansion functions. A long literal physical duct, which would maintain the pressure drop difference in the air behind the fans, and the outside air, inducing more air flow through the turbine fan, would not work in the turbulent flow environment associated with nearby structures. The structural mass over rotational center would be high, and the directional steering would be slow.

The concept of wake expansion behind a working fan is sometimes called diffusion augmentation. The extended outer steering flaps direct an outside of the center turbine fan volume of air outward. As the outwardly directed air molecule velocity from the sharp aerodynamic flap planar surface increases, the associated pressure in that equivalent air molecule volume inside of the flaps, and behind the fan, goes down. As the pressure drops behind the fan, more air is induced through the fan to normalize or make equivalent the total system air pressure, producing more power. This Bernoulli principle, simply stated, means that when velocity goes up, pressure within the stream flow goes down. This principle is used in spray paint cans, perfume atomizers and elsewhere.

This preferred embodiment described above represents the minimum number of aerodynamic elements required to fully reconcile instantaneous steering directly into the power source, the wind, with simultaneous complete control the various pressure environments inside and outside the working fans.

By comparison, a standard open fan is a propeller without an airplane, with much incoming air molecule energy directed uselessly outward along the extended blade structures, exerting no torque force on the fan blades.

The magnetic flux density produced by the embodiment described above is a high harmonic sinusoidally distributed field that approximates a square wave to provide a low harmonic dc waveform after rectification and filtering. While the embodiments shown include a single row of magnets positioned on the rotor, other configurations can be used. For example, a second row of magnets could be inside the stator. The magnets could be in a row on the outside as shown in FIG. 3, on the inside, or both on the inside and the outside.

While a combination of a DC machine and a wind turbine are described above, both the DC machine and the wind turbine are believed have novel aspects, be novel

Some embodiments of the invention include a ducted wind turbine, comprising:

a rotor shaft;

multiple fan blades extending from the rotor shaft, the fan blades causing the shaft to rotate as wind passes between the fan blades;

a rotor positioned at the end of the fan blades away from the rotor shaft so that the wind driving the fan blades passes between the rotor and the rotor shaft;

multiple magnets positioned on the rotor; and

a stator concentric with the rotor and including stator coils, the stator coils positioned adjacent to the rotor.

In some embodiments, the ducted wind turbine of further comprises vortex inducer configurable to increase wind power at low wind speeds.

In some embodiments, the vortex inducer comprises a Von Kármán vortex street.

In some embodiments, the ducted wind turbine further comprises a slip ring for transmitting control data for the vortex inducer.

In some embodiments, the ducted wind turbine, the multiple magnets are arranged with like poles facing each other in the plane of the rotor.

In some embodiments, the stator coils are arranged in pairs, each pair completing a magnetic circuit from a rotor magnet as the rotor magnet is facing the pair of stator coils.

In some embodiments, the ducted wind turbine further comprises rotor supports extending to the rotor from a collar over the rotor shaft.

In some embodiments, the rotor is positioned at a greater distance from the rotor shaft than is the stator.

In some embodiments, the ducted wind turbine of claim 1 further comprising multiple rectifiers positioned on the stator, a rectifier accepting alternating current from each pair of stator coil and delivering rectified current to a stator bus.

In some embodiments, the wind turbine generated power at wind speeds of between 2 mph and 100 mph.

In some embodiments, the ducted wind turbine of claim 1 further comprises a structure for automatic indexing of the ducted wind turbine.

In some embodiments, the ducted wind turbine of claim 1 further comprises a coanda flow enhancing air gap from which the pressure differentials induce laminar stream flow conforming to the planar steering structures.

Some embodiments of the invention include a brushless direct current machine, comprising:

a rotor assembly including

a rotor rotatable along a rotor axis; and

n rotor magnets mounted on said rotor, the magnets collectively having 2n poles, n being an even positive integer;

a stator assembly, including

a stator concentric with the rotor;

m stator coils positioned on said stator and facing said magnets in a non-overlapping predetermined angular relationship to each other about the axis of said rotor shaft, m being a positive integer,

said rotor magnets move adjacent to said stator coils as the rotor rotates to form magnetic circuits; and

a circuit connected with said stator coils and being disposed on said stator between said stator coils so as to be in non-overlapping relation to the latter.

In some embodiments, the brushless direct current machine further comprises:

a circuit for detecting the rotated angular position of the rotor and from which the current fed to the stator coils can be controlled; and

a printed circuit board disposed in a plane parallel to said axis of the rotor shaft and extending adjacent the end of the rotor assembly disposed nearest to said stator assembly.

In some embodiments, m is more than n and in other embodiments M is less than n.

In some embodiments, the brushless direct current machine further comprises a metallic base plate in electrical contact with the metallic shield.

In some embodiments, the rotor includes a rotor shaft and wherein the end of the rotor shaft nearest the stator assembly is clad with a conducting material, which can be connected to a common ground for grounding the rotor shaft.

In some embodiments, the detecting circuits can be comprised of at least a pair of sensor detectors disposed on said structure, a wiring circuit so as to be separated from each other about the axis of the rotor shaft by an angle related by an odd integer.

In some embodiments, a ducted wind turbine comprises an embodiment of the brushless direct current machine described above and fan blades that extend from a rotor hub to the rotor.

In some embodiments, the invention includes a brushless D.C. machine comprising:

a rotor including an extended rotor shaft;

a rotor assembly mounted on said rotor shaft;

an annular rotor magnet mounted on said rotor assembly and having consecutive poles spaced apart by approximately equal distances along its circumference, thereby providing a sinusoidal pattern of flux density with respect to the angular position of the rotor magnet;

a stator including a stator assembly and stator coils disposed on said stator assembly so as to face said magnet in a non-overlapping predetermined angular relationship to each other about the axis of said rotor shaft;

said rotor assembly and said stator assembly being closely adjacent to each other at their edges to define a relatively flat housing which contains said rotor magnet and which forms a magnetic circuit;

wiring circuits connected with said stator coils and being disposed on said stator assembly between said stator coils so as to be in non-overlapping relation to the latter; and

said stator coils, including the first and second pairs of stator coils, arranged with the axis of each coil parallel to said axis of the rotor shaft; each coil having edges that are in leading and trailing relation with respect to the direction of rotation of the rotor, each stator coil dimensioned so that an angular distance about said axis of the rotor shaft between the respective leading and trailing edges equals the angular distance between said consecutive poles of the rotor magnet, and said first and second pairs of stator coils, the first and second pairs of stator coils disposed at opposite sides of said wiring circuits, and the leading edge of one, and the trailing edge of the other of the coils of each said pair of stator coils, being angularly separated about said axis of the rotor shaft• by an angular distance equal to one-half the angular distance between said consecutive poles of the rotor magnet.

Some embodiments include sensors for detecting the rotated angular position of the rotor and from which the current fed to the stator coils can be controlled.

In some embodiments, the detecting sensors include a pair of sensor detectors mounted on said wiring circuits and disposed about said axis of the rotor shaft so that the angular distance between said detectors equals one-half the angular distance between said consecutive poles of the rotor magnet, and the angular distance between each said detector and the nearest edge there to of any of said stator coils equals one-half said angular distance between the consecutive poles of the rotor magnet.

In some embodiment, the invention includes a method of producing wind energy comprising:

providing a direct current machine as described above;

automatically indexing the wind turbine;

creating an enhanced double fan induced stream flow.

holding wake expansion aft of the fans open for the longest time to enhances the flow rate of power creating air molecules through the fans, by emulating an expanding physical duct system, in which the air mass subsequent to transit through the fans expands creating a volumetric pressure drop, inducing further air flow.

Although a particular embodiment of the invention has been described in detail herein with reference to the accompanying drawings, the invention is not limited to that precise embodiment. The drawings are not necessarily drawn to scale. Various changes and modifications may be effected therein by a person skilled in the art without departing from the scope or spirit of the invention as defined in the appended claims.

We claims as follows:

1. A ducted wind turbine, comprising:
a rotor shaft;
multiple fan blades extending from the rotor shaft, the fan blades causing the shaft to rotate as wind passes between the fan blades;
a rotor positioned at the end of the fan blades away from the rotor shaft so that the wind driving the fan blades passes between the rotor and the rotor shaft;
multiple magnets positioned on the rotor; and
a stator concentric with the rotor and including stator coils, the stator coils positioned adjacent to the rotor.

2. The ducted wind turbine of claim 1 further comprising a vortex inducer configurable to increase wind power at low wind speeds.

3. (canceled)

4. The ducted wind turbine of claim 1 further comprising a slip ring for transmitting control data for the vortex inducer.

5. The ducted wind turbine of claim 1 in which the multiple magnets are arranged with like poles facing each other in the plane of the rotor.

6. (canceled)

7. The ducted wind turbine of claim 1 further comprising rotor supports extending to the rotor from a collar over the rotor shaft.

8. The ducted wind turbine of claim 1 in which the rotor is positioned at a greater distance from the rotor shaft than is the stator.

9. The ducted wind turbine of claim 1 further comprising multiple rectifiers positioned on the stator, a rectifier accepting alternating current from each pair of stator coil and delivering rectified current to a stator bus.

10. (canceled)

11. (canceled)

12. The ducted wind turbine of claim 1 further comprising a coanda flow enhancing air gap from which the pressure differentials induce laminar stream flow conforming to the planar steering structures.

13. A brushless direct current machine, comprising:
a rotor assembly including
a rotor rotatable along a rotor axis; and
n rotor magnets mounted on said rotor, the magnets collectively having 2n poles, n being an even positive integer;
a stator assembly, including
a stator concentric with the rotor;
m stator coils positioned on said stator and facing said magnets in a non-overlapping predetermined angular relationship to each other about the axis of said rotor shaft, m being a positive integer,
said rotor magnets move adjacent to said stator coils as the rotor rotates to form magnetic circuits; and
a circuit connected with said stator coils and being disposed on said stator between said stator coils so as to be in non-overlapping relation to the latter.

14. A brushless direct current machine according to claim 1 further comprising:
a circuit for detecting the rotated angular position of the rotor and from which the current fed to the stator coils can be controlled; and
a printed circuit board disposed in a plane parallel to said axis of the rotor shaft and extending adjacent the end of the rotor assembly disposed nearest to said stator assembly.

15. A brushless direct current machine according to claim 13, in which m is more than n.

16. (canceled)

17. (canceled)

18. A brushless direct current machine according to claim 13 wherein the rotor includes a rotor shaft and wherein the end of the rotor shaft nearest the stator assembly is clad with a conducting material, which can be connected to a common ground for grounding the rotor shaft.

19. A brushless direct current machine according to claim 14 wherein said detecting circuits can be comprised of at least a pair of sensor detectors disposed on said structure, a wiring circuit so as to be separated from each other about the axis of the rotor shaft by an angle related by an odd integer.

20. A ducted wind turbine, comprising a brushless direct current machine in accordance with claim 13, in which fan blades extend from a rotor hub to the rotor.

21. A brushless D.C. machine comprising:
a rotor including an extended rotor shaft;
a rotor assembly mounted on said rotor shaft;
an annular rotor magnet mounted, on said rotor assembly and having consecutive poles spaced apart by approximately equal distances along its circumference, thereby providing a sinusoidal pattern of flux density with respect to the angular position of the rotor magnet;
a stator including a stator assembly and stator coils disposed on said stator assembly so as to face said magnet in a non-overlapping predetermined angular relationship to each other about the axis of said rotor shaft;
said rotor assembly and said stator assembly being closely adjacent to each other at their edges to define a relatively flat housing which contains said rotor magnet and which forms a magnetic circuit;
wiring circuits connected with said stator coils and being disposed on said stator assembly between said stator coils so as to be in non-overlapping relation to the latter; and
said stator coils, including the first and second pairs of stator coils, arranged with the axis of each coil parallel to said axis of the rotor shaft; each coil having edges that are in leading and trailing relation with respect to the direction of rotation of the rotor, each stator coil dimensioned so that an angular distance about said axis of the rotor shaft between the respective leading and trailing edges equals the angular distance between said consecutive poles of the rotor magnet, and said first and second pairs of stator coils, the first and second pairs of stator coils disposed at opposite sides of said wiring circuits, and the leading edge of one, and the trailing edge of the other of the coils of each said pair of stator coils, being angularly separated about said axis of the rotor shaft• by an angular distance equal to one-half the angular distance between said consecutive poles of the rotor magnet.

22. The brushless direct current machine of claim 21 further comprising detecting sensors for detecting the rotated angular position of the rotor and from which the current fed to the stator coils can be controlled.

23. The brushless direct current machine of claim 22 in which said detecting sensors include a pair of sensor detectors mounted on said wiring circuits and disposed about said axis of the rotor shaft so that the angular distance between said detectors equals one-half the angular distance between said consecutive poles of the rotor magnet, and the angular distance between each said detector and the nearest edge thereto of any of said stator coils equals one-half said angular distance between the consecutive poles of the rotor magnet.

24. A ducted fan wind turbine, comprising the brushless direct current machine of claim 22 and further comprising fan blades, the rotor is positioned at the distal end of the fan blades.

25. A ducted fan wind turbine in accordance with claim 24 further comprising a vortex generator to induce a low pressure region behind the fan blades.

26. A method of producing wind energy comprising:
providing a direct current machine in accordance with claim 22;
automatically indexing the wind turbine;
creating an enhanced double fan induced stream flow.
holding wake expansion aft of the fans open for the longest time to enhances the flow rate of power creating air molecules through the fans, by emulating an expanding physical duct system, in which the air mass subsequent to transit through the fans expands creating a volumetric pressure drop, inducing further air flow.
